(19) United States
(12) Patent Application Publication
(10) Pub. No.: US 2005/0271358 A1
(43) Pub. Date: Dec. 8, 2005

(54) Moving picture editing apparatus

(76) Inventors: Keisuke Inata, Yokohama (JP); Hironori Komi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/138,494

(22) Filed: May 27, 2005

(30) Foreign Application Priority Data
Jun. 4, 2004 (JP) 2004-167245

(51) Int. Cl. H04N 5/76; G11B 27/00

(52) U.S. Cl. 386/52; 386/55

(57) ABSTRACT

Input video information is subjected to two kinds of encoding processes by an encoding portion. Encoded video files A and B generated thus are recorded in a recording portion. An inputted edit command to edit desired video information is converted into an edit command by a user I/F portion. The edit command is supplied to edition portions A and B. Encoded video files A and B generated from the same video information are read out from the recording portion in accordance with the edit command. The encoded video file A is subjected to an edition process by the edition portion A while the encoded video file B is subjected to the edition process by the edition portion B. Edited video files A and B obtained by the edition process are supplied to the recording portion to rewrite corresponding encoded video files before edition therewith respectively.

### BACKGROUND OF THE INVENTION

The present invention relates to means and a technique in a field of a digital camera system or a video recorder system for encoding and recording video information, and particularly relates to means and a technique which can import video information, simultaneously encode the video information based on at least one kind of encoding system such as MPEG-2 or MPEG-4 (Moving Picture Experts Group Phase-4) so as to generate a first encoded video file and a second encoded video file, and on performing an edition process on the second encoded video file, automatically reflect the edition process on the first encoded video file.

The present invention further relates to means and a technique which can perform remote edition on the first encoded video file.

As has been often hitherto the case, inputted video information written and stored into a recording medium such as a hard disk is read out from the recording medium and displayed as video, or video information stored in a server is acquired through a network and browsed. There have been proposed techniques for editing such video information stored in the recording medium or the server.

As an example of the techniques, there has been proposed a technique in which book data stored in a server can be edited by page on each terminal through a network so that the same book data can be edited simultaneously on a plurality of terminals. When a terminal acquires a book object to be edited from a storage portion of the server and transmits an update command to the server, the server edits the book object to be edited in accordance with the update command, and stores a result of the edition into the aforementioned storage portion while transmitting the result of the edition to the terminal having issued the update command. When there is another terminal editing the same book object to be edited, the server also transmits the edition result to that terminal. Thus, according to this technique, a result of edition of one of terminals editing the same book object can be reflected on all the terminals (e.g. see JP-A-2001-256210).

As another example, there is a technique in which a moving picture file subjected to picture compression based on a standard such as MPEG (Moving Picture Experts Group) and recorded can be edited as the file is compressed. This technique extracts only moving picture data of an edition section from a video file and generates a new moving picture file from the extracted moving picture data. When the moving picture file has been subjected to picture compression based on MPEG, this edition section is edited by GOP (Group of Picture) so that one edited file is generated therefrom. When there are a plurality of edition sections, these edition sections are extracted from original moving picture files and connected to one another so that one moving picture file is generated (e.g. see JP-A-2003-319336)

### SUMMARY OF THE INVENTION

There can be considered a system in which the same video information is simultaneously recorded as files different in form so that one of the files can be read out and reproduced. For example, one of the files is recorded as a high-bit-rate encoded video file for a recording/storing purpose, and the other is recorded as a low-bit-rate encoded video file for use in a portable terminal or the like. When one of the encoded video files is edited in such a system, the same edition has to be performed on the other encoded video file generated from the same video information as the one encoded video file is generated. Even when the edition techniques disclosed in JP-A-2001-256210 and JP-A-2003-319336 are applied to the system, edition has to be performed on each of the encoded video files.

For example, for performing an edition process of cutting a part of an encoded video file, an editor performs designation of a cutting start position (edition process 1) and designation of a cutting end position (edition process 2) on the encoded video file to be edited, and then performs a cutting execution command (edition process 3) on the encoded video file. For performing such a cutting edition process on two encoded video files different in encoding system and generated from the same video information, the editor has to perform the same edition process on the two encoded video files individually, thereby causing labor and time, though cutting positions of these encoded video files are the same or have a correlation.

For example, in a system using a desktop type hard disk recorder, one and the same broadcast program received is recorded into the hard disk recorder in the form of a low-bit-rate encoded video file for use in a portable terminal or the like and a high-bit-rate encoded video file for a recording/storing purpose, so that the low-bit-rate encoded video file can be read into the portable terminal and viewed at any place. Assume that the low-bit-rate encoded video file can be edited on the portable terminal in the system. In this case, when the low-bit-rate encoded video file has been edited on the portable terminal, the high-bit-rate encoded video file and the low-bit-rate encoded video file both generated from the same broadcast program and recorded in the hard disk recorder have to be edited. To this end, a user, however, has to move to a place where the hard disk recorder storing these encoded video files is installed. Thus, labor increases correspondingly. These encoded video files in the hard disk recorder may be edited at the user's possible convenience, but there is a fear that the encoded video files are left unedited because the user forgets the edition or forgets the contents of the edition.

An object of the present invention is to solve the foregoing problems and to provide a moving picture editing system which can save labor for edition of two kinds of encoded video files generated from the same video information and recorded and apply the same edition to these encoded video files surely.

Another object of the present invention is to provide a moving picture editing system which can edit an encoded video file surely in spite of a distance from the place where a video signal is recorded as the encoded video file.

In order to attain these aforementioned objects, the present invention provides a moving picture editing system including: an encoding module which encodes inputted video information so as to generate first and second encoded video files; a recording module which records and stores the first and second encoded video files; a decoding module which imports the second encoded video file from the recording module in accordance with a reading instruction from the outside and decodes the second encoded video file, the second encoded video file being designated by the instruction; a display module which displays the video file decoded by the decoding module; a second edition module which imports the second encoded video file from the recording module in accordance with an edition command from the outside with respect to the second encoded video file recorded in the recording module, edits the second encoded video file, and records the edited second encoded video file in the recording module, the second encoded video file being designated by the edition command; and a first edition module which imports the first encoded video file from the recording module, edits the first encoded video file in parallel with an edition process of the second encoded video file performed by the second edition module, and records the edited first encoded video file in the recording module, the first encoded video file being generated from the same video information as the second encoded video file is generated; wherein the edition process of the second encoded video file is automatically reflected on the edition process of the first encoded video file.

The present invention further provides a moving picture editing system including: a first apparatus which stores inputted video information as first and second encoded video files different from each other; and a second apparatus which can import the second encoded video file from the first apparatus; the first apparatus including: an encoding module which encodes the inputted video information so as to generate the first and second encoded video files; a recording module which records and stores the first and second encoded video files; a first importing/exporting module which imports the second encoded video file from the recording module, exports the second encoded video file to the second apparatus, and records the second encoded video file from the second apparatus in the recording module; a reception module which receives an edition command from the outside; and a first edition module which imports the first encoded video file from the recording module, edits the first encoded video file and records the edited first encoded video file in the recording module in accordance with the edition command received by the reception module; the second apparatus including: a second importing/exporting module which imports the second encoded video file exported from the first importing/exporting module of the first apparatus, and exports the second encoded video file to the first importing/exporting module of the first apparatus; a second edition module which edits the second encoded video file in accordance with an edition command from the outside and exports the edited second encoded video file to the first importing/exporting module of the first apparatus from the second importing/exporting module, the second encoded video file being imported from the first apparatus by the second importing/exporting module; and a transmission module which transmits the edition command to the reception module of the first apparatus; wherein the first edition module of the first apparatus imports, from the recording module, the first encoded video file generated from the same video information as the second encoded video file is generated, and the first edition module edits the imported first encoded video file in accordance with the edition command from the second apparatus so that the edition process of the second encoded video file in the second apparatus is automatically reflected on the edition process of the first encoded video file.

The first importing/exporting module in the first apparatus is a first recording medium I/F module which can be removably loaded with a recording medium, so that the second encoded video file can be exchanged between the recording medium loaded on the first recording medium I/F module and the recording module; the second importing/exporting module in the second apparatus is a second recording medium I/F module which can be loaded with the recording medium, so that the second encoded video file can be exchanged between the recording medium loaded on the second recording medium I/F module and the second edition module; and exchange of the second encoded video file between the first apparatus and the second apparatus is performed through the recording medium.

The first importing/exporting module in the first apparatus includes a transmission module which transmits the second encoded video file imported from the recording module, and a reception module which receives the edited second encoded video file from the second apparatus; and the second importing/exporting module in the second apparatus includes a reception module which receives the second encoded video file transmitted from the transmission module of the first apparatus, and a transmission module which transmits the first apparatus the second encoded video file edited by the second edition module.

Further, one of the first and second encoded video files is a high-bit-rate high-quality encoded video file, and the other encoded video file is a low-bit-rate encoded video file; and the encoding module includes a first encoding circuit which encodes the video information so as to generate the high-bit-rate high-quality encoded video file, and a second encoding circuit which encodes the video information so as to generate the low-bit-rate encoded video file.

The first encoding circuit performs an encoding process based on an MPEG-2 standard and the second encoding circuit performs an encoding process based on an MPEG-4 standard.

Further, one of the first and second encoded video files is a high-bit-rate high-quality encoded video file, and the other encoded video file is a low-bit-rate encoded video file; and the encoding module includes an encoding circuit which encodes the video information so as to generate the high-bit-rate high-quality encoded video file, and a format conversion circuit which performs format conversion on the high-bit-rate high-quality encoded video file generated by the encoding circuit, so as to generate the low-bit-rate encoded video file.

Further, the encoding circuit performs an encoding process based on an MPEG-2 standard.

In order to attain the foregoing objects, the present invention provides a moving picture editing system including: a first apparatus which stores inputted video information as first and second encoded video files different from each other; and a second apparatus which can import the second encoded video file from the first apparatus; the first apparatus including: an encoding module which encodes the inputted video information so as to generate the first encoded video file high in bit rate; a recording module which records and stores the first encoded video file; a conversion module which converts the first encoded video file generated from the encoding module into the second encoded video file low in bit rate; an exporting module which exports the second encoded video file to the second apparatus; a reception module which receives an edition command from the outside; and a first edition module which imports the first encoded video file from the recording module, edits the first encoded video file and records the edited first encoded video file in the recording module in accordance with the edition command received by the reception module; the second apparatus including: an importing module which imports the second encoded video file exported from the exporting module of the first apparatus; a second edition module which edits the second encoded video file imported from the first apparatus by the importing module, in accordance with an edition command from the outside; a transmission module which transmits the edition command to the reception module of the first apparatus; and a module which decodes the second encoded video file edited by the second edition module and displays the decoded second encoded video file; wherein the first edition module in the first apparatus imports, from the recording module, the first encoded video file generated from the same video information as the second encoded video file is generated, and the first edition module edits the first encoded video file in accordance with the edition command from the second apparatus so that the edition process of the second encoded video file in the second apparatus is automatically reflected on the edition process of the first encoded video file.

The encoding module generates encoding information in parallel with the encoding process of the video information, and the encoding information is used for the edition process of the first or second encoded video file.

Assume that video information is edited in recording equipment in which one and the same video information is recorded as two kinds of encoded video files. In this event, according to the present invention, when one of the two kinds of encoded video files is edited, the same edition as that is automatically applied to the other encoded file. Thus, editor's edition works can be reduced and the two kinds of encoded video files generated from one and the same video information can always have the same contents.

Further, according to the present invention, when one of the encoded video files stored in the recording equipment is imported into portable equipment and edited on the portable equipment, the same edition as that is automatically applied to the other encoded video file stored in the recording equipment. Thus, remote edition can be performed.

Moreover, according to the present invention, even if only one kind of encoded video file is stored in the recording equipment, when the encoded video file is acquired by a terminal apparatus directly or after converted into a video file in a predetermined encoding system and edited, the same edition as that is automatically applied to the encoded video file stored in the recording equipment. Thus, remote edition of the encoded video file stored in such recording equipment can be performed.

### BRIEF DESCRIPTION OF THE DRAWINGS

These and other features, objects and advantages of the present invention will become more apparent from the following description when taken in conjunction with the accompany drawings where:

FIG. 1 is a configuration view showing a first embodiment of a moving picture editing system according to the present invention;

FIG. 2 is a block diagram showing a specific example of a recording/editing apparatus in FIG. 1;

FIGS. 3A and 3B are block diagrams showing specific examples of an encoding portion in FIG. 2;

FIG. 4 is a configuration view showing a second embodiment of the moving picture editing system according to the present invention;

FIG. 5 is a block diagram showing a specific example of a recording/editing apparatus in FIG. 4;

FIG. 6 is a block diagram showing a specific example of a terminal apparatus in FIG. 4;

FIG. 7 is a configuration view showing a third embodiment of the moving picture editing system according to the present invention;

FIG. 8 is a block diagram showing a specific example of a recording/editing apparatus in FIG. 7;

FIG. 9 is a block diagram showing a specific example of a terminal apparatus in FIG. 7;

FIG. 10 is a block diagram showing a specific example of a recording/editing apparatus in a fourth embodiment of the moving picture editing system according to the present invention; and

FIG. 11 is a block diagram showing a specific example of a terminal apparatus in the fourth embodiment of the moving picture editing system according to the present invention.

### DETAILED DESCRIPTION OF THE EMBODIMENTS

Embodiments of the invention will be described below with reference to the drawings.

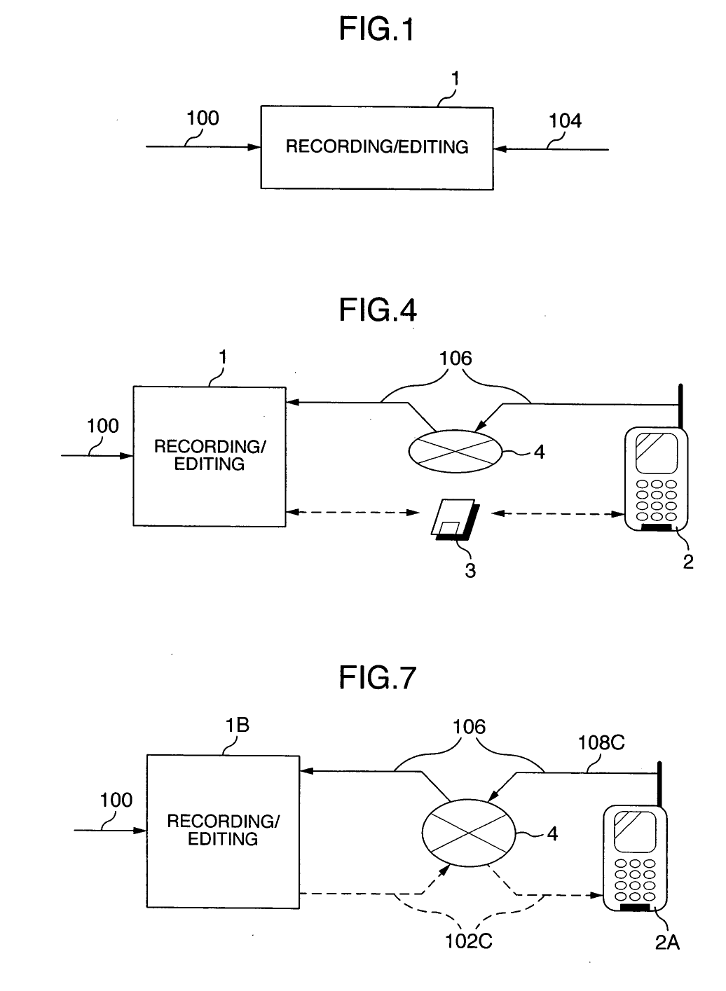

FIG. 1 is a configuration view showing a first embodiment of a moving picture editing system according to the invention. The reference numeral 1 designates a recording/editing apparatus.

In FIG. 1, the first embodiment is constituted by a recording/editing apparatus 1 provided with an edition function. Video information 100 supplied from a not-shown device such as a video camera or a broadcast program receiver is encoded and recorded as an encoded video file in the recording/editing apparatus 1. The encoded video file can be displayed as video on the recording/editing apparatus 1 and edited by the recording/editing apparatus 1 in accordance with an edit command 104 given to the recording/editing apparatus 1 due to an operation on a not-shown operation portion.

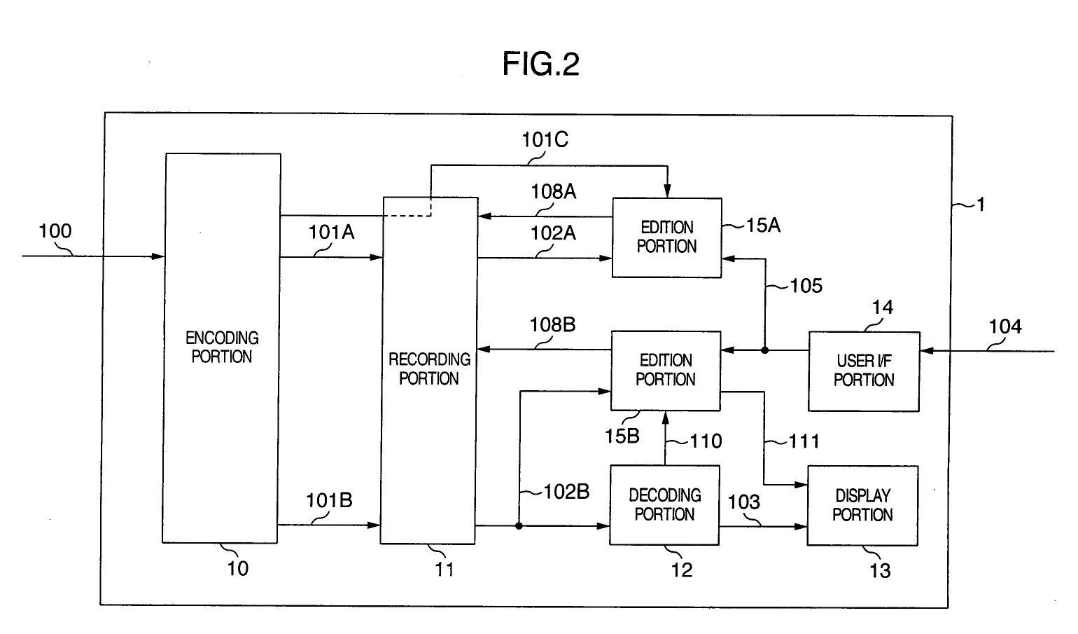

FIG. 2 is a block diagram showing a specific example of the recording/editing apparatus 1 in FIG. 1. The reference numeral 10 designates an encoding portion; 11, a recording portion; 12, a decoding portion; 13, a display portion; 14, a user I/F (interface) portion; and 15A or 15B, an editing portion.

In FIG. 2, the recording/editing apparatus 1 is a recorder, such as a hard disk recorder, provided with an edition function. When the inputted video information 100 is supplied to an encoding portion 10 in the recording/editing apparatus 1, the encoding portion 10 generates two kinds of encoded video files 101A and 101B. When the encoded video files 101A and 101B are generated, encoding information 101C is also generated. These encoded video files 101A and 101B and encoding information 101C generated thus are recorded in the recording portion 11. Additional information is added to the encoded video file 101A. The additional information includes information indicating the original video information 100 and information about the other encoded video file 1010B generated from the video information. Similarly, additional information is added to the encoded video file 101B. The additional information includes the information indicating the original video information 100 and information about the other encoded video file 101A generated from the video information.

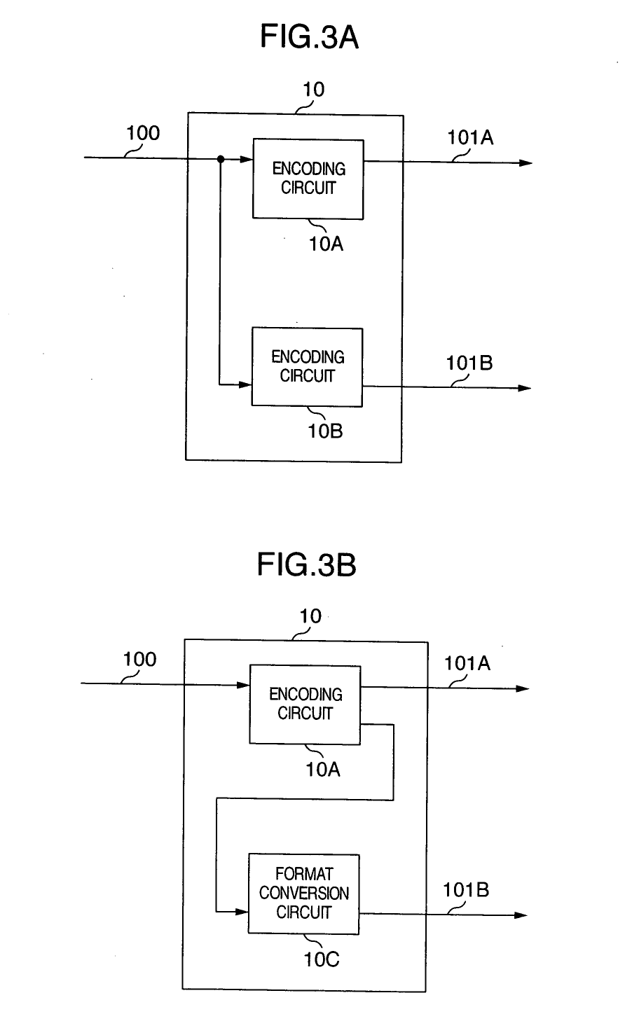

For example, MPEG standards can be used here as encoding systems in the encoding portion 10. Specific examples of the encoding portion 10 in this case are shown in FIGS. 3A and 3B.

The specific example shown in FIG. 3A is constituted by an encoding circuit 10A for performing an encoding process based on an MPEG-2 standard, and an encoding circuit 10B for performing an encoding process based on an MPEG-4 standard. Inputted video information 100 is subjected to an encoding process based on the MPEG-2 standard by the encoding circuit 10A so that an encoded video file 101A high in bit rate and used for high-quality moving pictures is generated. At the same time, the inputted video information 100 is also subjected to an encoding process based on the MPEG-4 standard by the encoding circuit 10B so that an encoded video file 101B low in bit rate and used for mobile communication etc. is generated.

The specific example shown in FIG. 3B is constituted by one encoding circuit 10A and one format conversion circuit 10C. Inputted video information 100 is subjected to an encoding process based on the MPEG-2 standard by the encoding circuit 10A so that a high-quality encoded video file 101A high in bit rate is generated. The encoded video file 101A is supplied to the format conversion circuit 10C so as to be subjected to a format conversion process so that an encoded video file 101B low in bit rate is generated. As the conversion process performed by the format conversion circuit 10C, for example, a transcoding process from MPEG-2 to MPEG-4, resolution conversion from the encoded video file 101A based on high resolution MPEG-2 to the encoded video file 101B based on low resolution MPEG-2, etc. may be used.

Return to FIG. 2. For example, the encoding information 101C is constituted by at least one of picture size information (height by width), picture type information (I, P, B pictures etc.), picture data volume information (by byte unit etc.), GOP structure information (number of pictures etc.), etc. Alternatively, the encoding information 101C may be information indicating a correlation between the encoded video files 101A and 101B. As an example of the information indicating the correlation, there is information indicating corresponding GOP start positions, frame positions, etc. of the encoded video files 101A and 101B. For example, the encoding information 101C as the information indicating the corresponding GOP start positions is information constituted by the pair of the information of the GOP start position of the encoded video file 101A and the information of the GOP start position of the encoded video file 101B corresponding to the GOP start position of the encoded video file 101A (that is, information indicating correspondence between the GOP start positions of the two files). The encoding information 101C as information expressing the frame positions is constituted similarly but using the frame positions. The same thing can also apply to the embodiments which will be described later.

The recording portion 11 is a drive using a recording medium such as a hard disk, a semiconductor memory, an optical disk such as a DVD or a blue-ray optical disk, etc. The recoding portion 11 has a configuration in which the encoded video files 101A and 101B and further the encoding information 101C can be recorded simultaneously, and in which the encoded video files 101A and 101B and further the encoding information 101C can be reproduced simultaneously or the encoded video files 101A and 101B can be reproduced separately. Further, the recording portion 11 can perform recording and reproduction simultaneously. This thing can also apply to the embodiments which will be described later. Incidentally, the recording/editing apparatus 1 is a recorder provided with such a drive.

When a user performs a predetermined operation for browsing a video file recorded in the recording portion 11, of the encoded video file 101B recorded in the recording portion 11, a video file designated by the user is read out as an encoded video file 102B. The encoded video file 102B is supplied to the decoding portion 12 so as to be decoded into a video signal 103. This video signal 103 is supplied to the display portion 13 so that the designated video file is displayed on the display portion 13. Incidentally, the encoded video file 101A may be read out and displayed as video on the display portion 13. In the following description, assume that the encoded video file 102B low in bit rate is displayed as video on the display portion 13.

When a video file recorded in the recording portion 11 is to be edited, the video file to be edited is read from the recording portion 11 and an edition section can be specified while the video file is monitored on the display portion 13 as described above. When the specified section for editing the video file is determined thus and the user performs an edition operation through an ON/OFF operation on a physical operation button or through an external input device (such as a keyboard, a remote controller, etc.), an edit command 104 with respect to the video file to be edited is supplied to the user I/F portion 14. The user I/F portion 14 converts the edit command 104 into an edit command 105 which is, for example, constituted by a read command to read the video file designated as a file to be edited, a cutting start position designation command or a cutting end position designation command to be used at the time of cutting the specified section for editing the encoded video file, a cutting edition start command, etc. The edit command 105 is supplied to the edition portions 15A and 15B.

In accordance with the edit command 105, the designated video file is retrieved from the recording portion 11 based on the aforementioned additional information, and the encoded video files 102A and 102B of the designated video file are read out. Thus reading out the encoded video files from the recording portion 11 is performed by a not-shown management portion.

The encoded video file 102B read out from the recording portion 11 is decoded by the decoding portion 12 and displayed as video on the display portion 13, as described above. At the same time, the encoded video file 102B is also supplied to the edition portion 15B, subjected to an edition process (cutting edition of the specified section in this case) by the edition portion 15B in accordance with the edit command 105 from the user I/F portion 14, and recorded as an edited encoded video file 108B in the recording portion 11. When the encoded video file 102B is decoded by the decoding portion 12, decoding information 110 constituted by at least one of picture size information (height by width), picture type information (I, P, B pictures etc.), picture data volume information (by byte unit etc.) and GOP structure information (number of pictures etc.) may be generated about the encoded video file 102B. In that case, the edition portion 15B may use the decoding information 110 in the edition process.

The encoded video file 102A read out from the recording portion 11 is supplied to the edition portion 15A and subjected to an edition process (cutting edition of the specified section in this case) by the edition portion 15A in accordance with the edit command 105 from the user I/F portion 14. The edited contents of the encoded video file 102A by the edition portion 15A are the same as the edited contents of the encoded video file 102B by the edition portion 15B. Accordingly, when cutting edition of the specified section is performed on the encoded video file 102B by the edition portion 15B, cutting edition of a specified section corresponding to the specified section of the encoded video file 102B subjected to the cutting edition by the edition portion 15B is also performed on the encoded video file 102A by the edition portion 15A. In the following description, the editions performed thus by the edition portions 15A and 15B will be referred to as the same edition. Accordingly, in the aforementioned case, the same edition as the edition performed on the encoded video file 102B by the edition portion 15B is performed on the encoded video file 102A by the edition portion 15A.

The encoded video file 102A edited by the edition portion 15A is recorded as an edited encoded video file 108A in the recording portion 11.

Incidentally, when the aforementioned encoding information 101C has been generated and recorded in the recording portion 11, the encoding information 101C may be read out as soon as the encoded video files 102A and 102B are read out from the recording portion 11. Thus, the encoding information 101C can be used when the encoded video file 102A is edited by the edition portion 15A. In addition, the encoding information 101C may be used in place of the decoding information 110 from the decoding portion 12 when the encoded video file 102B is edited by the edition portion 15B. It is a matter of course that, if the encoding information 101C has not been generated, the decoding information 110 generated by the edition portion 15B may be used when the encoded video file 102A is edited by the edition portion 15A.

The encoding information 101C or the decoding information 110 is used for retrieving a cutting start position or a cutting end position of the encoded video file 102A or 102B in accordance with the edit command 105. For example, when a predetermined GOP start position of the encoded video file 102B is designated as a cutting start position in accordance with the edit command 105, the GOP start position of the encoded video file 102A corresponding to the GOP start position serving as the cutting start position of the encoded video file 102B in accordance with the edit command 105 can be determined by use of the encoding information 101C so that this GOP start position can be set as the cutting start position of the encoded video file 102A. In this manner, only if an editor (user) designates a predetermined GOP start position of one encoded video file as a cutting start position thereof, the GOP start position of the other encoded video file corresponding to the predetermined GOP start position can be designated as a cutting start position of the other encoded video file. The same thing can apply to the case where the decoding information 110 is used.

The edition portion 15B may display the encoding information 101C or the decoding information 110, the edit command 105, and a video image of the edited decoded video file 108B, collectively as edition information 111, on the display portion 13 at the time of editing the encoded video file 102B. In this case, the edited encoded video file 108B is supplied to the decoding portion 12 and decoded therein. The encoding information 101C or the decoding information 110, and the edit command 105 are displayed on the display portion 13 by OSD (On Screen Display) so as to be superimposed on the display screen of the video signal 103 from the decoding portion 12. The video signal 103 in this case may be the encoded video file 102B read out from the recording portion 11 and decoded by the decoding portion 12 or may be the encoded video file 108B edited by the edition portion 15B and decoded by the decoding portion 12.

In the first embodiment, when the edition process is performed thus on the encoded video file 102B, the edition process is automatically reflected on the encoded video file 102A. Accordingly, in order to edit two encoded video files 102A and 102B generated from the same video information 100, the user may just perform an edition operation on one encoded video file 102B. Thus, labor and time for the operation can be reduced on a large scale.

The operation in which the recording/editing apparatus 1 is a hard disk recorder will be described here.

When a broadcast program desired by a user is received by a not-shown receiver due to the user's operation on a button of a body of the recording/editing apparatus or on a remote controller, the contents (that is, video information and audio information. This will apply to the following description) of the broadcast program are inputted as broadcast contents information 100 into the hard disk recorder 1. Here, on the assumption that the encoding portion 10 has the configuration shown in FIG. 3A, the program contents information 100 is supplied to the encoding portion 10 and encoded therein so that an encoded program information file 101A based on the MPEG-2 standard and an encoded program information file 101B based on the MPEG-4 standard are generated and recorded in the recording portion 11 respectively.

The desired broadcast program selected by the user is recorded thus in the recording portion 11. When an edit command 104 of a desired program video information file is transmitted to the hard disk recorder 1 due to the user's operation on a button of the body of the recording/editing apparatus or the user's edition operation on the remote controller, an edit command 105 is generated from the edit command 104 by the user I/F portion 14 in the hard disk recorder 1. In accordance with the edit command 105, an encoded program information file 102B read out from the recording portion 11 is edited by the edition portion 15B and recorded as an edited encoded program information file 108B in the recording portion 11.

In parallel with that, the edit command 105 from the user I/F portion 14 is also supplied to the edition portion 15A so that an encoded program information file 102A based on the MPEG-2 standard and generated from the same broadcast program as the encoded program information file 102B edited by the edition portion 15B is read out from the recording portion 11, and the same edition process as that performed on the encoded program information file 102B is automatically performed on the encoded program information file 102A by the edition portion 15A. An edited encoded program information file 108A obtained thus is recorded in the recording portion 11. In the recording portion 11, the encoded program information files 102A and 102B of the broadcast program before edition are rewritten by the edited encoded program information files 108A and 108B. Incidentally, such rewriting is also performed in other embodiments which will be described later, but description thereof will be omitted.

By the aforementioned edition, the edited encoded program information files 108A and 108B are recorded in the recording portion 11 as program video information files designated to edit by the user.

Incidentally, in the aforementioned edition, encoding information 101C, decoding information 110, or the like can be used as described above. In addition, edition information 111 or a video image of the edited encoded program file can be displayed on the display portion 13 in the aforementioned manner.

Thus, only if an operation of editing the encoded program information file 102B encoded and recorded based on the MPEG-4 standard is performed, the encoded program information file 102A encoded and recorded from the same program contents information 100 based on the MPEG-2 standard can be edited simultaneously. Alternatively, configuration may be made so that when an operation of editing the encoded program information file 102A based on the MPEG-2 standard is performed, the encoded program information file 102B based on the MPEG-4 standard can be edited with the same contents automatically. Although the encoded program information file 102B encoded based on the MPEG-4 standard is used as the program video information file decoded by the decoding portion 12 and displayed as video on the display portion 13, the encoded program information file 102A encoded based on the MPEG-2 standard may be used alternatively. As the program information file encoded and recorded in the recording portion 11, audio data may be used, video data may be used, any other data may be used, or any combination of these data may be used. When different kinds of data are handled thus, at least the encoding portion 10 and the edition portions 15A and 15B are provided for each kind of data. This thing can apply to the embodiments which will be described later.

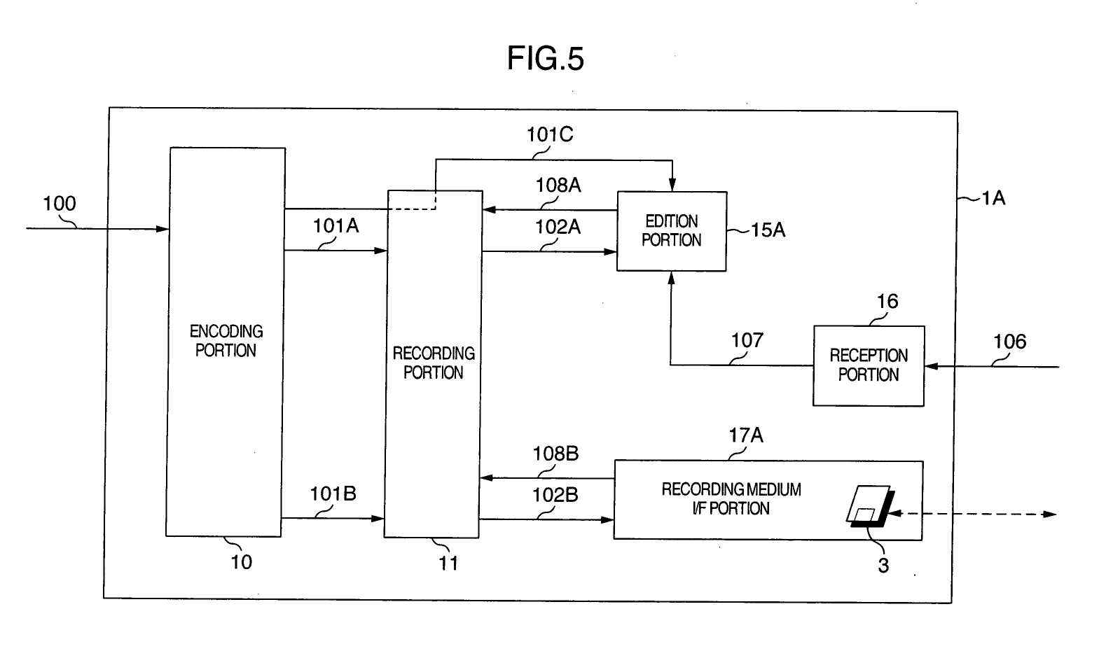

FIG. 4 is a configuration view showing a second embodiment of the moving picture recording system according to the invention. The reference numeral 1A designates a recording/editing apparatus; 2, a terminal apparatus; 3, a recording medium; and 4, a transmission path. Parts corresponding to those in FIG. 1 are designated by reference numerals the same as those in FIG. 1.

In FIG. 4, the recording/editing apparatus 1A encodes inputted video information 100 in the same manner as the recording/editing apparatus 1 in FIG. 2. As a result, two kinds of encoded video files are generated and recorded. In addition, it is made possible to edit one of the recorded encoded video files. Further, in the recording/editing apparatus 1A, it is also made possible to exchange the other encoded video file with the terminal apparatus 2 through the recording medium 3.

The terminal apparatus 2 can edit the other encoded video file imported from the recording/editing apparatus 1A through the recording medium 3. When the terminal apparatus 2 transmits an edit command 106 to the recording/editing apparatus 1A through the transmission path 4 at the time of the edition, the recording/editing apparatus 1A can edit the one encoded video file. When the other encoded video file edited by the terminal apparatus 2 is transmitted to the recording/editing apparatus 1A through the recording medium 3, the other encoded video file is recorded in the recording/editing apparatus 1A.

In the second embodiment, when one of the encoded video files is edited thus by the terminal apparatus 2, the other encoded video file generated from the same video information 100 as the one encoded video file is automatically edited with the same contents in the recording/editing apparatus 1A.

Incidentally, portable equipment such as a cellular phone or a PDA, a portable or desktop PC, or the like, may be used as the terminal apparatus 2. A hard disk, a semiconductor memory, an optical disk such as a DVD or a blue-ray optical disk, or the like, may be used as the recording medium 3. The transmission path 4 may a wireless transmission path including an Internet connection network or a cellular phone network, or a cable transmission path, a transmission path using optical fibers or the like may be used as the transmission path 4. This thing can apply to the embodiments which will be described later.

FIG. 5 is a block diagram showing a specific example of the recording/editing apparatus 1A in FIG. 4. The reference numeral 16 designates a reception portion; and 17A, a recording medium I/F portion. Parts corresponding to those in FIGS. 2 and 4 are designated by reference numerals the same as those in FIGS. 2 and 4 and duplicate description thereof will be omitted.

In FIG. 5, the recording/editing apparatus 1A is a disk recorder such as a hard disk recorder provided with an edition function, similarly to the recording/editing apparatus 1 shown in FIG. 2. In the recording/editing apparatus 1A, video information 100 inputted from the outside is encoded by the encoding portion 10 so that encoded video files 101A and 101B added with the aforementioned additional information are generated and recorded in the recording portion 11. At the same time, encoding information 101C may be also generated and recorded in the recording portion 11.

The recording/editing apparatus 1A is provided with the recording medium I/F portion 17A so that the recording medium 3 can be removably loaded on the recording medium I/F portion 17A. When a user operates a not-shown operation portion to designate a video information file in the condition that the recording medium 3 is loaded on the recording medium I/F portion 17A, a designated encoded video file 102B is retrieved and read out from the recording portion 11 by a not-shown management portion based on the additional information. This encoded video information file 102B is recorded in the recording medium 3 and the encoded video file recorded in the recording medium 3 is recorded in the recording portion 11. Accordingly, the user loads the recording medium 3 onto the recording medium I/F portion 17A, reads the encoded video file 102B of the desired video information from the recording portion 11 and records the encoded video file 102B in the recording medium 3. After that, the user removes the recording medium 3 from the recording medium I/F portion 17A and loads the recording medium 3 onto the terminal apparatus 2 (FIG. 4). Thus, the encoded video file 102B recorded in the recording medium 3 can be imported into the terminal apparatus 2 so that the imported encoded video file 102B can be reproduced, displayed and edited.

When the encoded video file 102B acquired from the recording/editing apparatus 1A as described above is edited thus by the terminal apparatus 2, an edit command 106 to edit the other encoded video file 101A generated from the same video information 100 as the encoded video file 102B and recorded in the recording portion 11 is sent from the terminal apparatus 2 to the recording/editing apparatus 1A through the transmission path 4 (FIG. 4). The edit command 106 is similar to a modulated one of the edit command 104 in FIG. 2. The edit command 106 is received and demodulated by the reception portion 16. The reception portion 16 has a reception function of the edit command 106 and a function similar to that of the user I/F portion 14 in FIG. 2. Accordingly, the reception portion 16 demodulates the received edit command 106 and generates an edit command 107 similar to the edit command 105 in FIG. 2. In accordance with the edit command 107, the edition portion 15A reads the encoded video file 101A to be edited as an encoded video file 102A from the recording portion 11 and edits the encoded video file 102A in association with the edition process of the encoded video file 102B in the terminal apparatus 2 (FIG. 4). That is, an edition process whose contents are the same as the contents of the edition process performed on the encoded video file 102B in the terminal apparatus 2 is performed on the encoded video file 102A by the edition portion 15A. The encoded video file 102B edited thus is recorded as an edited encoded video file 108A in the recording portion 11.

When the recording medium 3 in which the edited encoded video file 108B is recorded by the terminal apparatus 2 is loaded on the recording medium I/F portion 17A, the edited encoded video file 108B is read out from the recording medium 3 and recorded in the recording portion 11.

In this manner, the encoded video files 102A and 102B generated from the same video information 100 before edition are rewritten by the identically edited encoded video files 108A and 108B in the recording portion 11.

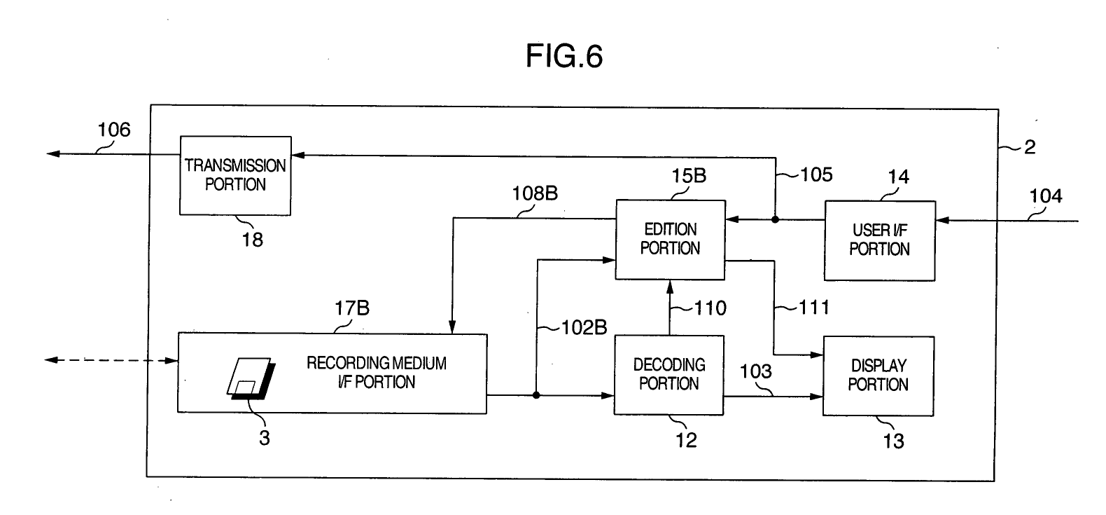

FIG. 6 is a block diagram showing a specific example of the terminal apparatus 2 in FIG. 4. The reference numeral 17B designates a recording medium I/F portion; and 18, a transmission portion. Parts corresponding to those in FIG. 2 are designated by reference numerals the same as those in FIG. 2, and duplicate description thereof will be omitted.

In FIG. 6, the terminal apparatus 2 is provided with a decoding portion 12, a display portion 13, a user I/F portion 14 and an edition portion 15B which operate respectively in the same manner as the decoding portion 12, the display portion 13, the user I/F portion 14 and the edition portion 15B provided in recording/editing apparatus 1 shown in FIG. 2. In addition, the terminal apparatus 2 is also provided with a recording medium I/F portion 17B and a transmission portion 18.

The recording medium I/F portion 17B can be used so that the recording medium 3 to be used in the recording medium I/F portion 17A of the recording/editing apparatus 1A shown in FIG. 5 can be removably loaded on the recording medium I/F portion 17B. When the recording medium 3 is loaded on the recording medium I/F portion 17B, the encoded video file 102B recorded in the recording medium 3 can be read out, decoded by the decoding portion 12, and displayed on the display portion 13. The encoded video file 102B can be subjected to an edition process by the edition portion 15B in accordance with an edit command 105. When the encoded video file 102B is to be edited by the edition portion 15B, an encoded video file 108B edited by the edition process is recorded in the recording medium 3. As described above, the encoded video file 102B recorded in the recording medium 3 is an encoded video file 102B read out from the recording portion 11 by the recording medium I/F portion 17A of the recording/editing apparatus 1A (FIG. 5) and recorded in the recording medium 3.

When the encoded video file 102B recorded in the recording medium 3 is to be edited, the edit command 105 generated from the edit command 104 by the user I/F portion 14 is supplied to the edition portion 15B. At the same time, the edit command 105 is also supplied to the transmission portion 18, modulated and transmitted as the aforementioned edit command 106 to the recording/edition apparatus 1A (FIG. 5) through the transmission path 4 (FIG. 4).

The encoded video file 108B edited by the edition portion 15B is recorded in the recording portion 3 by the recording medium I/F portion 17B. After that, the recording medium 3 is loaded on the recording medium I/F portion 17A of the recording/editing apparatus 1A in FIG. 5, so that the edited encoded video file 108B is recorded in the recording portion 11.

Although the embodiment has been described in the case where the encoded video file 102B is edited by the terminal apparatus 2 while the encoded video file 102A is edited by the recording/editing apparatus 1A, it is also applicable to the reverse case. In that case, in the recording/editing apparatus 1A shown in FIG. 5, the encoded video file 102A read out from the recording portion 11 is recorded in the recording medium 3 loaded on the recording medium I/F portion 17A and the edition portion 15B for editing the encoded video file 102B is provided in place of the edition portion 15A for editing the encoded video file 102A. In the terminal apparatus 2 shown in FIG. 6, the edition portion 15A for editing the encoded video file 102A is provided in place of the edition portion 15B for editing the encoded video file 102B.

Next, an example of an operation of the second embodiment will be described on this assumption that the recording/editing apparatus 1A is a hard disk recorder, the encoding portion 10 has the configuration as shown in FIG. 3A, the terminal apparatus 2 is a cellular phone, the transmission path 4 is the Internet, and the recording medium 3 is a semiconductor memory. Incidentally, in the example, an encoded video file 102B is edited by the cellular phone 2.

When a broadcast program desired by a user is received by a not-shown receiver due to the user's operation on a button or operation on a remote controller in the same manner as that in the hard disk recorder 1 in FIG. 2, the contents of the broadcast program are inputted as program contents information 100 into the hard disk recorder 1A in FIG. 5. The program contents information 100 is supplied to the encoding portion 10 and encoded therein so that an encoded program information file 101A based on the MPEG-2 standard and an encoded program information file 101B based on the MPEG-4 standard are generated and recorded in the recording portion 11 respectively. As a result, the encoded program information files 101A and 101B of the desired broadcast program are recorded in the recording portion 11.

When the user loads the semiconductor memory 3 onto the recording medium I/F portion 17A and performs an operation to designate a file of the desired broadcast program, an encoded program information file 102B of the designated broadcast program based on the MPEG-4 standard is retrieved and read out from the recording portion 11 based on the additional information of the encoded program information file 102B, and written in the recording medium 3.

When the user then removes the semiconductor memory 3 from the recording medium I/F portion 17A and loads the semiconductor memory 3 onto the recording medium I/F portion 17B of the cellular phone 2 shown in FIG. 6, the encoded program information file 102B recorded in the semiconductor memory 3 can be reproduced, displayed and edited.

That is, when the user operates the cellular phone 2 in order to reproduce and display the encoded program information file 102B, the encoded program information file 102B is read out from the semiconductor memory 3, decoded by the decoded portion 12, and supplied as a program video signal 103 to the display portion 13. As a result, the broadcast program of the encoded program information file 102B is displayed.

When the user operates the cellular phone 2 to give an instruction of edition, an edit command 104 is inputted to the user I/F portion 14 and converted into an edit command 105 by the user I/F portion 14 so that the edit command 105 is supplied to the edition portion 15B. When the edit command 105 is received by the edition portion 15B, the encoded program information file 102B is read and imported from the semiconductor memory 3, and edited in accordance with the edit command 105. The encoded program information file 102B edited thus is recorded as an edited encoded program information file 108B into the semiconductor memory 3 on the recording medium I/F portion 17B. As a result, in the semiconductor memory 3, the encoded, program information file 102B can be rewritten by the edited encoded program information file 108B. Incidentally, the encoded program information file 102B is decoded and displayed on the display portion 13 in advance. The user can decide how to edit the encoded program information file 102B while viewing the display contents of the encoded program information file 102B. Thus, the edit command 104 is generated. Display on the display portion 13 at the time of edition is the same as that in the recording/editing apparatus 1 shown in FIG. 2.

In addition, the edit command 105 is also supplied to the transmission portion 108, modulated, and transmitted as an edit command 106 to the hard disk recorder 1A shown in FIG. 5, through the Internet 4 (FIG. 4). Incidentally, information about the video information 100 (FIG. 5) of the broadcast program as a source of the encoded program information file 102B is also added to the edit command 104, based on the additional information of the encoded program information file 102B recorded in the semiconductor memory 3. The edit command 104 with this information is transmitted as the edit command 106.

In the hard disk recorder 1A shown in FIG. 5, the edit command 106 is received and demodulated by the reception portion 16 so that an edit command 107 is obtained and supplied to the edition portion 15A. A corresponding encoded program information file 102A read out from the recording portion 11 based on the aforementioned information added to the edit command 107 is edited by the edition portion 15A in accordance with the edit command 107 and recorded as an edited encoded program video file 108A in the recording portion 11.

As described above, the second embodiment is different from the first embodiment in that the apparatus for the user to perform an edition operation is the terminal apparatus 2. However, when the user operates to edit one of the encoded video files 102A and 102B generated from the same video information 100 in the recording portion 11, the same edition process is performed on the other encoded video file automatically and simultaneously. Thus, an effect similar to that of the first embodiment can be obtained in the second embodiment. Further, remote edition from the terminal apparatus 2 can be performed. Thus, while browsing one of the video information files on the terminal apparatus 2, the user can edit the other encoded video file stored in the recording/editing apparatus 1A without going to the recording/editing apparatus 1A.

The second embodiment has been described in the case where one of the encoded program information files 102A and 102B is edited by the terminal apparatus 2 while the other encoded program information file is edited correspondingly by the recording/editing apparatus 1A. Alternatively, the recording/editing apparatus 1A may be provided with edition portions respectively for the two encoded video files so that the two encoded video files can be edited by the recording/editing apparatus 1A in the same manner as by the recording/editing apparatus 1 shown in FIG. 2, in addition to remote edition performed by the terminal apparatus 2.

In addition, the recording/editing apparatus 1A may be further provided with a decoding portion and a display portion so that the encoded video file recorded in the recording portion 11 can be displayed on the recording/editing apparatus 1A.

Further, the edit command 105 to be transmitted through the transmission path 4 may be encrypted. In this case, a process of demodulating and decoding (decrypting) the received edit command 106 is performed by the reception portion 16 (FIG. 5).

Furthermore, an encoded video file to be recorded in the recording medium 3 may be encrypted. In this case, an encryption/decryption portion is provided in each of the recording medium I/F portion 17A of the recording/editing apparatus 1A and the recording medium I/F portion 17B of the terminal apparatus 2.

Moreover, when the encoded video file 102B read out from the recording portion 11 is recorded in the recording medium 3 loaded on the recording medium I/F portion 17A, the encoding information 101C recorded in the recording portion 11 may be also read out and recorded in the recording medium. Thus, the encoding information 101C can be used when the encoded video file 102B is edited by the edition portion 15B of the terminal apparatus 2.

FIG. 7 is a configuration view showing a third embodiment of the moving picture recording system according to the invention. The reference numeral 1B designates a recording/editing apparatus; and 2A, a terminal apparatus. Parts corresponding to those in FIG. 4 are designated by reference numerals the same as those in FIG. 4.

In the second embodiment shown in FIGS. 4 to 6, an encoded video file is exchanged between the recording/editing apparatus 1A and the terminal apparatus 2 through the recording medium 3. In the third embodiment shown in FIG. 7, such exchange is performed through a transmission path 4.

That is, when a desired video information file is requested from a terminal apparatus 2A through the transmission path 4, an encoded video file 102B corresponding to the requested file is read out from an internal recording portion, and transmitted to the terminal apparatus 2A through the transmission path 4. In the terminal apparatus 2A, the encoded video file 102B can be received, displayed on a display portion and edited. When the encoded video file 102B is to be edited, an edit command 106 is transmitted from the terminal apparatus 2A to the recording/editing apparatus 1B through the transmission path 4, and an edited encoded video file 108B is transmitted as an edited encoded video file 108C to the recording/editing apparatus 1B through the transmission path 4. In the recording/editing apparatus 1B, the edited encoded video file 108B received thus is recorded in the internal recording portion.

Like the aforementioned embodiments, the recording portion is a drive of a hard disk, a semiconductor memory, or an optical disk such as a DVD or a blue-ray optical disk, and the recording/editing apparatus 1B is a recorder etc. provided with such a drive. The terminal apparatus 2A is a cellular phone, a portable terminal (PDA), a portable or desktop personal computer, or the like.

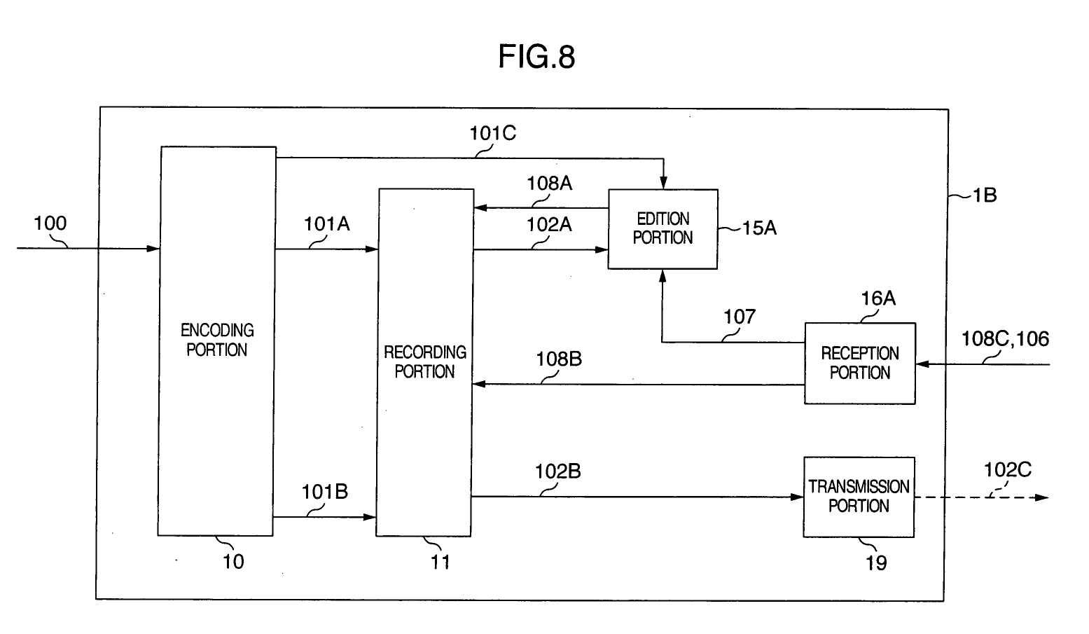

FIG. 8 is a block diagram showing a specific example of the recording/editing apparatus 1B in FIG. 7. The reference numeral 16A designates a reception portion; and 19, a transmission portion. Parts corresponding to those in FIG. 5 are designated by reference numerals the same as those in FIG. 5, and duplicate description thereof will be omitted.

In FIG. 8, the recording/editing apparatus 1B basically has the same configuration and the same function as those of the recording/editing apparatus 1A shown in FIG. 5. In order to perform file communication with the terminal apparatus 2A, the recording/editing apparatus 1B is provided with a transmission portion 19 in place of the recording medium I/F portion 17A in the recording/editing apparatus 1A, and a reception portion 16A in place of the reception portion 16 in the recording/editing apparatus 1A.

The reception portion 16A receives an edited encoded video file 108C from the terminal apparatus 2A as well as a modulated read command and a modulated edit command 106 of an encoded video file. On receiving the read command, the reception portion 16A demodulates the read command and transmits the demodulated read command to a not-shown management portion. This management portion reads out an encoded video file 102B corresponding to the designated video information file, from the recoding portion 11 in accordance with the read command. The encoded video file 102B read out thus is supplied to the transmission portion 19, demodulated, and transmitted as an encoded video file 102C to the terminal apparatus 2A through the transmission path 4 (FIG. 7).

On receiving the modulated edit command 106, the reception portion 16A demodulates the received edit command 106, generates an edit command 107 and supplies the edit command 107 to the edition 15A, in the same manner as the reception portion 16 of the recording/editing apparatus 1A shown in FIG. 5. The edition portion 15A reads an encoded video file 102A of the video information designated by the edit command 107 from the recording portion 11, edits the encoded video file 102A and records the encoded video file 102A as an edited encoded video file 108A in the recording portion 11.

Further, the reception portion 16A receives the edited encoded video file 108C, demodulates the edited encoded video file 108C into an edited encoded video file 108B, and records the edited encoded video file 108B in the recording portion 11.

Except the aforementioned points, the recording/editing apparatus 1B is identical to the recording/editing apparatus 1A shown in FIG. 5.

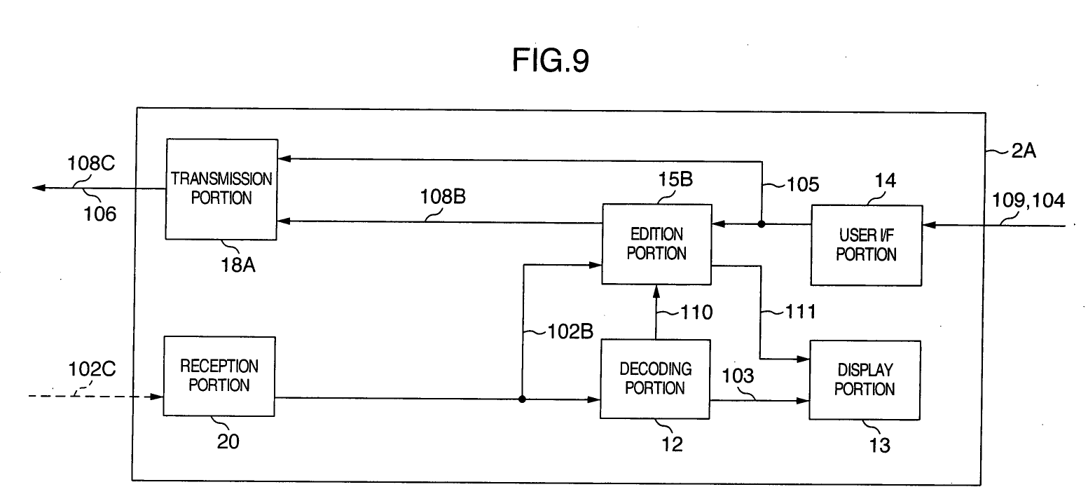

FIG. 9 is a block diagram showing a specific example of the terminal apparatus 2A in FIG. 7. The reference numeral 18A designates a transmission portion; and 20, a reception portion. Parts corresponding to those in FIG. 6 are designated by reference numerals the same as those in FIG. 6, and duplicate description thereof will be omitted.

In FIG. 9, the terminal apparatus 2A basically has the same configuration and the same function as those of the terminal apparatus 2 shown in FIG. 6. In order to perform file communication with the recording/editing apparatus 1B, the terminal apparatus 2A is provided with a reception portion 20 in place of the recording medium I/F portion 17B in the terminal apparatus 2 (FIG. 6), and a transmission portion 18A in place of the transmission portion 18 in the terminal apparatus 2.

The reception portion 20 receives an edited encoded video file 102C transmitted from the transmission portion 19 of the recording/editing apparatus 1B and modulates the edited encoded video file 102C into an encoded video file 102B. The encoded video file 102B is supplied to the edition portion 15B and the decoding portion 12.

In order to import a desired video information file from the recording portion 11 (FIG. 8) of the recording/editing apparatus 1B and display the desired video information file as video, the user performs a predetermined operation so that a read command 109 designating the file is inputted to the user I/F portion 14, subjected to a predetermined process, modulated by the transmission portion 18A and transmitted to the recording/editing apparatus 1B through the transmission path 4. When the encoded video file 102C of the video information file designated in accordance with the command 109 is received by the reception portion 20 through the transmission path 4, the encoded video file 102C is demodulated into the encoded video file 102B. The encoded video file 102B demodulated thus is decoded by the decoding portion 12 and supplied as a video signal 103 to the display portion 13. As a result, the designated file is displayed as video.

In order to edit a desired video information file recorded in the recording portion 11 (FIG. 8) of the recording/editing apparatus 1B, the user performs a predetermined operation on the terminal apparatus 2A so that an edit command 104 including a command for designating this desired file is inputted to the user I/F portion 14. An edit command 105 is generated from the edit command 104 by the user I/F portion 14 and supplied to the edition portion 15B. At the same time, the edit command 105 is also supplied to the transmission portion 18A, modulated, and supplied as an edit command 106 to the recording/editing apparatus 1B shown in FIG. 8 through the transmission path 4.

When the edit command 106 is received by the reception portion 16A in the recording/editing apparatus 1B, the edit command 106 is demodulated and the command for designating the video information file is extracted from the edit command 106. Based on this extracted command, the not-shown management portion reads out encoded video files 102A and 102B of the designated file from the recording portion 11. An edit command 107 is generated from the edit command 106 by the reception portion 16A and supplied to the edition portion 15A.

The encoded video file 102A read out from the recording portion 11 is edited in accordance with the edit command 107 by the edition portion 15A and recorded as an edited encoded video file 108A in the recording portion 11. The encoded video file 102B is supplied to the transmission portion 19, modulated, and transmitted as an encoded video file 102C to the terminal apparatus 2A through the transmission path 4 (FIG. 7).

In the terminal apparatus 2A shown in FIG. 9, the encoded video file 102C from the recording/editing apparatus 1B is received and modulated by the reception portion 20, and supplied as the encoded video file 102B to the edition portion 15B. The encoded video file 102B is edited by the edition portion 15B in accordance with the edit command 105 from the user I/F portion 14. An edited encoded video file 108B obtained thus is supplied to the transmission portion 18A, modulated and transmitted as an encoded video file 108C to the recording/editing apparatus 1B shown in FIG. 8 through the transmission path 4. In the recording/editing apparatus 1B, the encoded video file 108C is received and modulated by the reception portion 16A and recorded as the edited encoded video file 108B in the recording portion 11 under the control of the not-shown management portion.

Next, an example of an operation of the third embodiment will be described on this assumption that the recording/editing apparatus 1B is a hard disk recorder, the encoding portion 10 has the configuration as shown in FIG. 3A, the terminal apparatus 2A is a cellular phone, and the transmission path 4 is the Internet. Incidentally, in the example, assume that an encoded video file 102B is edited by the cellular phone 2.

When a broadcast program desired by the user is received by a not-shown receiver due to the user's operation on a button or operation on a remote controller in the same manner as that in the hard disk recorder 1 in FIG. 2, the contents of the broadcast program are inputted as program contents information 100 into the hard disk recorder 1B in FIG. 8. The program contents information 100 is supplied to the encoding portion 10 and encoded therein so that an encoded program information file 101A based on the MPEG-2 standard and an encoded program information file 101B based on the MPEG-4 standard are generated and recorded in the recording portion 11 respectively. As a result, the encoded program information files 101A and 101B of the desired broadcast program are recorded in the recording portion 11.

When the user performs an operation on the cellular phone 2A so as to designate a file of a desired broadcast program, a read command 109 is transmitted from the cellular phone 2A to the recording/editing apparatus 1B as described above. In the recording/editing apparatus 1B, the read command 109 is received by the reception portion 16A and an encoded program information file 102B of the designated file based on the MPEG-4 standard is retrieved and read out from the recording portion 11 based on the aforementioned additional information added to the encoded program information file 102B. The encoded program information file 102B is supplied to the transmission portion 19, modulated and transmitted as an encoded program video file 102C to the cellular phone 2A through the Internet 4.

In the cellular phone 2A, the encoded program information file 102C is received and demodulated by the reception portion 20, decoded by the decoding portion 12 and supplied to the display portion 13. As a result, the designated broadcast program file can be displayed on the cellular phone 2A.

When the user performs an operation on the cellular phone 2A to give an instruction of edition, an edit command 104 is inputted to the user I/F portion 14 and converted into an edit command 105. The edit command 105 is supplied to the edition portion 15B. At the same time, the edit command 105 is also transmitted to the transmission portion 18A, modulated and transmitted as an edit command 106 to the hard disk recorder 1B shown in FIG. 8 through the Internet 4 (FIG. 7). Incidentally, the edition information 104 is added with information about the video information 100 (FIG. 8) of the broadcast program to be edited, and transmitted as the edit command 106.

In the hard disk recorder 1B shown in FIG. 8, the edit command 106 is received and demodulated by the reception portion 16A. An edit command 107 obtained thus is supplied to the edition portion 15A. A corresponding encoded program information file 102A read out from the recording portion 11 based on the aforementioned information added to the edit command 107 is edited by the edition portion 15A in accordance with the edit command 107 and recorded as an edited encoded program information file 108A in the recording portion 11.

In addition, in the hard disk recorder 1B, a corresponding encoded program information file 102B is read out from the recording portion 11 in accordance with the received edit command 107, and modulated and transmitted as an encoded program information file 102C to the cellular phone 2A shown in FIG. 9 through the Internet 4 by the transmission portion 19.

In the cellular phone 2A, the encoded program information file 102C is received and demodulated by the reception portion 20, supplied to the edition portion 15B and subjected to an edition process by the edition portion 15B in accordance with the edit command 105. An edited encoded video file 108B obtained by the edition process is modulated and transmitted by the transmission portion 18A to the recording/editing apparatus 1B shown in FIG. 8 through the Internet 4. In the recording/editing apparatus 1B, the edited encoded program video file 108B is received and demodulated by the reception portion 16A and recorded in the recording portion 11.

When the user performs an operation to edit one of the encoded video files 102A and 102B generated from the same video information 100 and recorded in the recording portion 11 in the aforementioned manner, the other encoded video file is subjected to the same edition automatically and simultaneously. In addition, remote edition is available. Accordingly, the third embodiment can obtain an effect similar to that of the second embodiment.

In addition, in the third embodiment, the video file stored in the recording portion 11 of the recording/editing apparatus 1B is transmitted to the terminal apparatus 2A by communication. Accordingly, labor for carrying the file in the form of a recording medium can be saved, as compared with the second embodiment. Further, since the edited file is transmitted to the recording/editing apparatus 1B by communication, labor for carrying the edited file to the recording/editing apparatus 1B in the form of a recording medium can be saved, and the edited file can be transmitted to the recording/editing apparatus 1B and surely recorded in the recording portion 11 as soon as the edition process is performed.

Also in the third embodiment, when one of the encoded program information files 102A and 102B is edited by the terminal apparatus 2A, the other encoded program information file can be edited correspondingly by the recording/editing apparatus 1B. Alternatively, the recording/editing apparatus 1B may be provided with edition portions respectively for the two encoded video files 102A and 102B so that the two encoded video files 102A and 102B can be edited by the recording/editing apparatus 1B in the same manner as by the recording/editing apparatus 1 shown in FIG. 2, in addition to remote edition performed by the terminal apparatus 2A.

In addition, the recording/editing apparatus 1B may be provided with a decoding portion and a display portion so that the encoded video file recorded in the recording portion 11 can be displayed on the recording/editing apparatus 1B.

Further, the read command, the edit command 105, and the encoded video file to be transmitted through the transmission path 4 may be encrypted. In this case, a process of demodulating and decoding (decrypting) a received signal is performed by the reception portion 16A (FIG. 8) or the reception portion 20 (FIG. 9)

Furthermore, when the encoded video file 102B read out from the recording portion 11 is transmitted from the transmission portion 19 to the terminal apparatus 2A, the encoding information 101C recorded in the recording portion 11 may be also read out and transmitted to the terminal apparatus 2A. Thus, the encoding information 101C can be used when the encoded video file 102B is edited by the edition portion 15B of the terminal apparatus 2A.

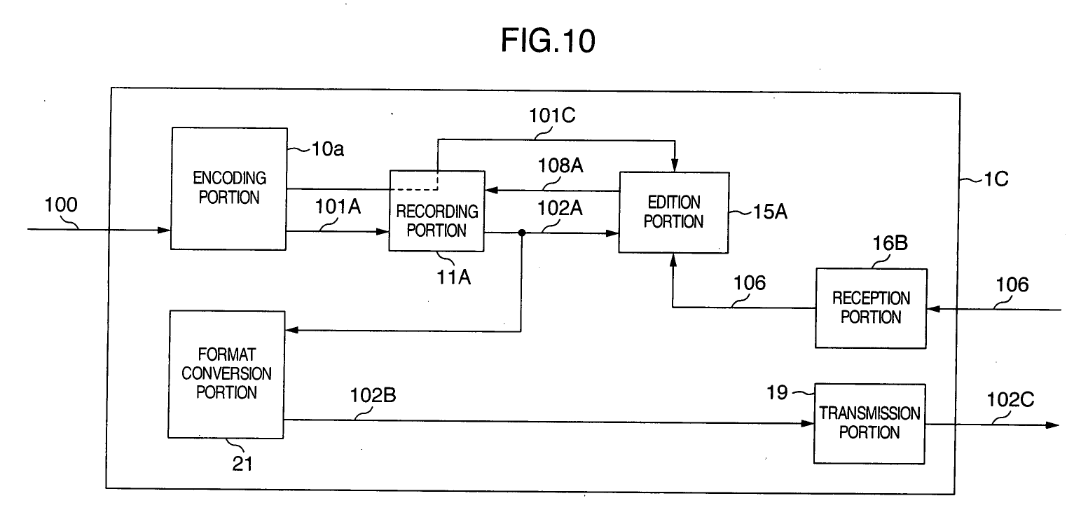

FIG. 10 is a block diagram showing a specific example of a recording/editing apparatus in a fourth embodiment of the moving picture recording system according to the invention. The reference numeral 1C designates a recording/editing apparatus as the specific example; 10a, an encoding portion; 11A, a recording portion; 16B, a reception portion; and 21, a format conversion portion. Parts corresponding to those in FIG. 8 are designated by reference numerals the same as those in FIG. 8, and duplicate description thereof will be omitted. Incidentally, the entire configuration of the fourth embodiment is the same as that of the third embodiment shown in FIG. 7.

In FIG. 10, a recording/editing apparatus 1C includes an encoding portion 10a as the encoding portion for encoding inputted video information 100, together with a recording portion 11A. The encoding portion 10a encodes the video information 100 only into an encoded video file 101A based on the MPEG-2 standard. The recording portion 11A records and stores the encoded video file 101A. Incidentally, when encoding information 101C is generated by the encoding portion 10a, the encoding information 101C is also recorded in the recording portion 11A.

The recording/editing apparatus 1C is also provided with a format conversion portion 21. The format conversion portion 21 is similar to the format conversion circuit 10C in FIG. 3B. The format conversion portion 21 performs format conversion (e.g. transcoding from MPEG-2 to MPEG-4, or resolution conversion from high resolution MPEG-2 to low resolution MPEG-2) on an encoded video file 102A (the same as the encoded video file 101A) read out from the recording portion 11A. An encoded video file 102B obtained by such format conversion is the same as the encoded video file 101B obtained by the encoding portion 10 having the configuration shown in FIG. 3B in the recording/editing apparatus according to the previous embodiments. The encoded video file 102B is transmitted as an encoded video file 102C from the transmission portion 19 through the transmission path in the same manner as that in the third embodiment shown FIG. 7.

Incidentally, the recording portion 11A is a drive of a hard disk, a semiconductor memory, or an optical disk such as a DVD or a blue-ray optical disk. The recording/editing apparatus 1C is a recorder provided with such a drive. A terminal apparatus 2B is a cellular phone, a portable terminal (PDA), a portable or desktop personal computer, or the like.

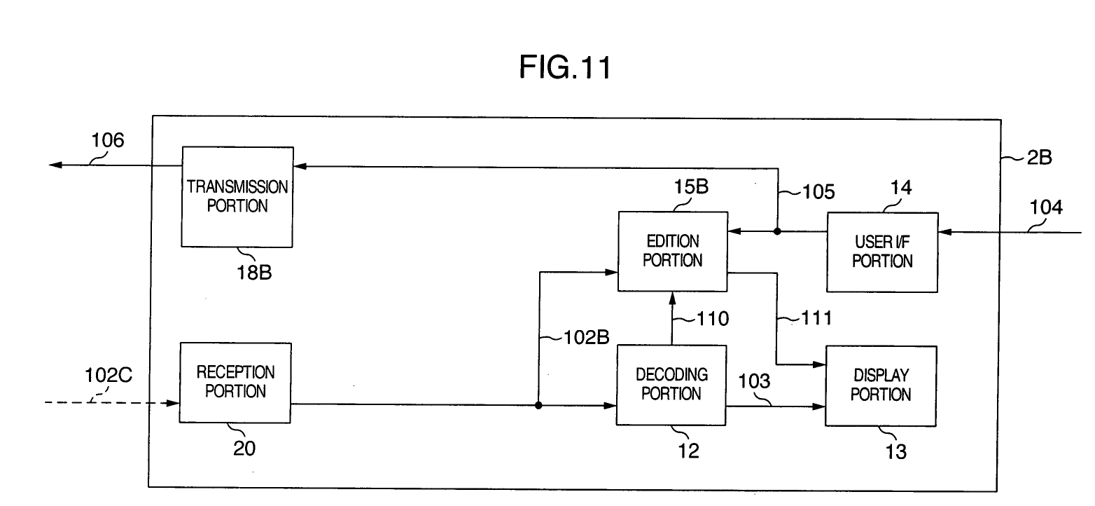

FIG. 11 is a block diagram showing a specific example of a terminal apparatus in the fourth embodiment. The reference numeral 2B designates a terminal apparatus as the specific example; and 18B, a transmission portion. Parts corresponding to those in FIGS. 6 and 9 are designated by reference numerals the same as FIGS. 6 and 9, and duplicate description thereof will be omitted.

In FIG. 11, the terminal apparatus 2B is provided with a transmission portion 18B for transmitting a read command and an edit command 105 of a desired encoded video file to the recording/editing apparatus 1C. The remaining configuration is the same as that of the terminal apparatus 2A in the third embodiment shown in FIG. 9.

When a user now performs a predetermined operation on the terminal apparatus 2B to designate a desired video information file in order to import this file from the recording/editing apparatus 1C to the terminal apparatus 2B, a read command generated by this operation is inputted to the user I/F portion 14 and subjected to a predetermined process by the user I/F portion 14. Then, the read command is transmitted from the transmission portion 18B to the recording/editing apparatus 1C shown in FIG. 10 through the transmission path.

When the user performs a predetermined operation to designate a desired video information file stored in the recording/editing apparatus 1C in order to edit this file, an edit command 104 generated by this operation is inputted to the user I/F portion 14, subjected to the predetermined process by the user I/F portion 14 and supplied as an edit command 105 to the edition portion 15B. At the same time, the edit command 105 is also supplied to the transmission portion 18B and supplied as an edit command 106 to the recording/editing apparatus 1C shown in FIG. 10 through the transmission path.

When the read command from the terminal apparatus 2B (FIG. 11) is received by the reception portion 16B in the recording/editing apparatus 1C, an encoded video file 102A of the video information file designated by the read command is read out from the recording portion 11A by a not-shown management portion and converted into an encoded video file 102B by the format conversion portion 21 as described above. Then, the encoded video file 102B is transmitted as an encoded video file 102C from the transmission portion 19 to the terminal apparatus 2B shown in FIG. 11.

In the terminal apparatus 2B, the encoded video file 102C is received and demodulated into the encoded video file 102B by the reception portion 20. The encoded video file 102B demodulated thus is decoded into a video signal 103 by the decoding portion 12 and supplied to the display portion 13. As a result, the video information file designated by the user is displayed on the display portion 13. When editing the video information file, for example, the user can determine a cutting start position or a cutting end position for performing cutting edition on a specified section of the file while viewing a display screen of the video information.

When the edit command 106 from the terminal apparatus 2B (FIG. 11) is received by the reception portion 16 in the recording/editing apparatus 1C shown in FIG. 10, an edit command 107 is generated from the edit command 106 and supplied to the edition portion 15A. At the same time, the not-shown management portion reads out the encoded video file 102A of the video information file designated by the edit command 107, from the recording portion 11A. The encoded video file 102A is edited by the edition portion 15A in accordance with the edit command 107. An edited encoded video file 108A obtained thus is recorded in the recording portion 11A. The encoded video file 102A read out from the recording portion 11A is converted into the encoded video file 102B by the format conversion portion 21 and the encoded video file 102B is transmitted as the encoded video file 102C to the terminal apparatus 2B shown in FIG. 11, as described above.

In the terminal apparatus 2B, the encoded video file 102C transmitted from the recording/editing apparatus 1C (FIG. 10) is received and demodulated into the encoded video file 102B by the reception portion 20. The encoded video file 102B is supplied to the edition portion 15B and subjected to an edition process by the edition portion 15B in accordance with the edit command 105 from the user I/F portion 14. The edited file of the encoded video file 102B is decoded by the decoding portion 12 and supplied as a decoded video signal 103 to the display portion 13. Accordingly, the user confirms a result of the edition.

Next, an example of an operation of the fourth embodiment will be described on the assumption that the recording/editing apparatus 1C is a hard disk recorder, the terminal apparatus 2B is a cellular phone, and the transmission path between the hard disk recorder 1C and the cellular phone 2B is the Internet.

When a broadcast program desired by a user is received by a not-shown receiver due to the user's operation on a button or operation on a remote controller in the same manner as that in the hard disk recorder 1 in FIG. 2, the contents of the broadcast program are inputted as program contents information 100 into the hard disk recorder 1C in FIGS. 10 and 11. The program contents information 100 is supplied to the encoding portion 10a and encoded by the encoding portion 10a so that an encoded program information file 101A based on the MPEG-2 standard is generated and recorded in the recording portion 11A. As a result, the desired received broadcast program is recorded as the encoded program information file 101A in the recording portion 11A.

When the user performs an operation on the cellular phone 2B so as to designate a desired broadcast program file stored in the recording/editing apparatus 1C, a read command is transmitted from the cellular phone 2B to the recording/editing apparatus 1C as described above. In the recording/editing apparatus 1C, the read command is received by the reception portion 16B so that an encoded program information file 102A of the designated broadcast program based on the MPEG-2 standard is retrieved and read out from the recording portion 11A based on the aforementioned additional information added to the program information file 102A. The encoded program information file 102A is converted into an encoded program information file 102B with another format by the format conversion portion 21. The encoded program information file 102B is supplied to the transmission portion 19, and modulated and transmitted as an encoded program information file 102C to the cellular phone 2B through the Internet by the transmission portion 19.

In the cellular phone 2B, the encoded program information file 102C is received and demodulated into the encoded program information file 102B by the reception portion 20. The demodulated encoded program information file 102B is decoded into video information 103 by the decoding portion 12. The video information 103 is supplied to the display portion 13. As a result, the contents of the designated received broadcast program are displayed on the cellular phone 2B.

Further, when the user performs an operation on the cellular phone 2B so as to give an instruction of edition over the desired broadcast program file stored in the recording/editing apparatus 1C, an edit command 104 is inputted to the user I/F portion 14 and converted into an edit command 105. The edit command 105 is supplied to the edition portion 15B. At the same time, the edit command 105 is also supplied to the transmission portion 18B, modulated and transmitted as an edit command 106 to the hard disk recorder 1C through the Internet. Incidentally, the edit command 104 is added with information about the video information file of the broadcast program to be edited. The edit command 106 also contains such information.

In the hard disk recorder 1C, the edit command 106 is received and demodulated by the reception portion 16B. An edit command 107 obtained thus is supplied to the edition portion 15A. A corresponding encoded program information file 102A is read out from the recording portion 11A based on the aforementioned information added to the edit command 107, edited by the edition portion 15A in accordance with the edit command 107 and recorded as an edited encoded program information file 108A in the recording portion 11A. In the hard disk recorder 1C, the corresponding encoded program information file 102A is read out from the recording portion 11A in accordance with the received edit command 107 and converted into an encoded program information file 102B by the format conversion portion 21. Then, the encoded program information file 102B is modulated and transmitted as an encoded program information file 102C to the cellular phone 2B through the Internet by the transmission portion 19.

In the cellular phone 2B, the encoded program information file 102C is received and demodulated into the encoded program information file 102B by the reception portion 20. The encoded program information file 102B demodulated thus is supplied to the edition portion 15B and edited by the edition portion 15B in accordance with the edit command 105. An edited encoded program information file obtained by the edition is decoded into video information 103 by the decoding portion 12. The video information 103 is supplied to the display portion 13. As a result, the user can confirm a result of the edition on the display portion 13.

As described above, in the fourth embodiment, the desired video file recorded in the recording portion 11A of the recording/editing apparatus 1C can be edited remotely from the terminal apparatus 2B by use of a video file identical thereto but different in encoding system. In addition, the edition result can be confirmed on the terminal apparatus 2B, and labor for importing the video file from the recording/editing apparatus 1C to the terminal apparatus 2B can be saved. Thus, an effect similar to that of the third embodiment can be obtained. Further, the video file encoded in one kind of encoding system is recorded in the recording portion 11A of the recording/editing apparatus 1C. Therefore, it is possible to store more video files and it is possible to edit the respective video files remotely.

Also in the fourth embodiment, the recording/editing apparatus 1C may be provided with a decoding portion and a display portion so that the encoded video file 102A recorded in the recording portion 11A can be displayed on the recording/editing apparatus 1C.

In addition, the read command, the edit command 105 and the encoded video file 102B to be transmitted through the transmission path may be encrypted. In this case, a process of demodulating and decoding a received signal is performed by the reception portion 16B (FIG. 10) or the reception portion 20 (FIG. 11).

Further, the encoded video file 102A based on the MPEG-2 standard and read out from the recording portion 11A may be transmitted from the transmission portion 19 to the terminal apparatus 2B. In this case, the format conversion portion 21 can be dispensed with in the recording/editing apparatus 1C.

Furthermore, when the encoded video file 102B is transmitted from the transmission portion 19 to the terminal apparatus 2B, the encoding information 101C recorded in the recording portion 11A may be also read out and transmitted to the terminal apparatus 2B. Thus, the encoding information 101C can be used when the encoded video file 102B is edited by the edition portion 15B of the terminal apparatus 2B.

Incidentally, the encoding portion 10a and the recording portion 11A in the recording/editing apparatus 1C shown in FIG. 10 may be used in place of the encoding portion 10 and the recording portion 11 in each of the recording/editing apparatus 1 shown in FIG. 2, the recording/editing apparatus 1A shown in FIG. 5 and the recording/editing apparatus 1B shown in FIG. 8.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

1. A moving picture editing system comprising:
an encoding module which encodes inputted video information so as to generate first and second encoded video files;
a recording module which records and stores the first and second encoded video files;
a decoding module which imports the second encoded video file from the recording module in accordance with a reading instruction from the outside and decodes the second encoded video file, the second encoded video file being designated by the instruction;
a display module which displays the video file decoded by the decoding module;
a second edition module which imports the second encoded video file from the recording module in accordance with an edition command from the outside with respect to the second encoded video file recorded in the recording module, edits the second encoded video file, and records the edited second encoded video file in the recording module, the second encoded video file being designated by the edition command; and
a first edition module which imports the first encoded video file from the recording module, edits the first encoded video file in parallel with an edition process of the second encoded video file performed by the second edition module, and records the edited first encoded video file in the recording module, the first encoded video file being generated from the same video information as the second encoded video file is generated;wherein:
the edition process of the second encoded video file is automatically reflected on the edition process of the first encoded video file.

2. A moving picture editing system comprising:
a first apparatus which stores inputted video information as first and second encoded video files different from each other; and
a second apparatus which can import the second encoded video file from the first apparatus;
the first apparatus including:
an encoding module which encodes the inputted video information so as to generate the first and second encoded video files;
a recording module which records and stores the first and second encoded video files;
a first importing/exporting module which imports the second encoded video file from the recording module, exports the second encoded video file to the second apparatus, and records the second encoded video file from the second apparatus in the recording module;
a reception module which receives an edition command from the outside; and
a first edition module which imports the first encoded video file from the recording module, edits the first encoded video file and records the edited first encoded video file in the recording module in accordance with the edition command received by the reception module;
the second apparatus including:
a second importing/exporting module which imports the second encoded video file exported from the first importing/exporting module of the first apparatus, and exports the second encoded video file to the first importing/exporting module of the first apparatus;
a second edition module which edits the second encoded video file in accordance with an edition command from the outside and exports the edited second encoded video file to the first importing/exporting module of the first apparatus from the second importing/exporting module, the second encoded video file being imported from the first apparatus by the second importing/exporting module; and
a transmission module which transmits the edition command to the reception module of the first apparatus; wherein:
the first edition module of the first apparatus imports, from the recording module, the first encoded video file generated from the same video information as the second encoded video file is generated, and the first edition module edits the imported first encoded video file in accordance with the edition command from the second apparatus so that the edition process of the second encoded video file in the second apparatus is automatically reflected on the edition process of the first encoded video file.

3. A moving picture editing system according to claim 2, wherein:
the first importing/exporting module in the first apparatus is a first recording medium I/F module which can be removably loaded with a recording medium, so that the second encoded video file can be exchanged between the recording medium loaded on the first recording medium I/F module and the recording module;
the second importing/exporting module in the second apparatus is a second recording medium I/F module which can be loaded with the recording medium, so that the second encoded video file can be exchanged between the recording medium loaded on the second recording medium I/F module and the second edition module; and
exchange of the second encoded video file between the first apparatus and the second apparatus is performed through the recording medium.

4. A moving picture editing system according to claim 2, wherein:
the first importing/exporting module in the first apparatus includes a transmission module which transmits the second encoded video file imported from the recording module, and a reception module which receives the edited second encoded video file from the second apparatus; and
the second importing/exporting module in the second apparatus includes a reception module which receives the second encoded video file transmitted from the transmission module of the first apparatus, and a transmission module which transmits the first apparatus the second encoded video file edited by the second edition module.

5. A moving picture editing system according to claim 4, wherein:
one of the first and second encoded video files is a high-bit-rate high-quality encoded video file, and the other encoded video file is a low-bit-rate encoded video file; and
the encoding module includes a first encoding circuit which encodes the video information so as to generate the high-bit-rate high-quality encoded video file, and a second encoding circuit which encodes the video information so as to generate the low-bit-rate encoded video file.

6. A moving picture editing system according to claim 5, wherein:
the first encoding circuit performs an encoding process based on an MPEG-2 standard and the second encoding circuit performs an encoding process based on an MPEG-4 standard.

7. A moving picture editing system according to claim 4, wherein:
one of the first and second encoded video files is a high-bit-rate high-quality encoded video file, and the other encoded video file is a low-bit-rate encoded video file; and
the encoding module includes an encoding circuit which encodes the video information so as to generate the high-bit-rate high-quality encoded video file, and a format conversion circuit which performs format conversion on the high-bit-rate high-quality encoded video file generated by the encoding circuit, so as to generate the low-bit-rate encoded video file.

8. A moving picture editing system according to claim 7, wherein:
the encoding circuit performs an encoding process based on an MPEG-2 standard.

9. A moving picture editing system according to claim 1, wherein:
one of the first and second encoded video files is a high-bit-rate high-quality encoded video file, and the other encoded video file is a low-bit-rate encoded video file; and
the encoding module includes a first encoding circuit which encodes the video information so as to generate the high-bit-rate high-quality encoded video file, and a second encoding circuit which encodes the video information so as to generate the low-bit-rate encoded video file.

10. A moving picture editing system according to claim 1, wherein:
one of the first and second encoded video files is a high-bit-rate high-quality encoded video file, and the other encoded video file is a low-bit-rate encoded video file; and
the encoding module includes an encoding circuit which encodes the video information so as to generate the high-bit-rate high-quality encoded video file, and a format conversion circuit which performs format conversion on the high-bit-rate high-quality encoded video file generated by the encoding circuit, so as to generate the low-bit-rate encoded video file.

11. A moving picture editing system comprising:
a first apparatus which stores inputted video information as first and second encoded video files different from each other; and
a second apparatus which can import the second encoded video file from the first apparatus;
the first apparatus including:
an encoding module which encodes the inputted video information so as to generate the first encoded video file high in bit rate;
a recording module which records and stores the first encoded video file;
a conversion module which converts the first encoded video file generated from the encoding module into the second encoded video file low in bit rate;
an exporting module which exports the second encoded video file to the second apparatus;
a reception module which receives an edition command from the outside; and
a first edition module which imports the first encoded video file from the recording module, edits the first encoded video file and records the edited first encoded video file in the recording module in accordance with the edition command received by the reception module;
the second apparatus including:
an importing module which imports the second encoded video file exported from the exporting module of the first apparatus;
a second edition module which edits the second encoded video file imported from the first apparatus by the importing module, in accordance with an edition command from the outside;
a transmission module which transmits the edition command to the reception module of the first apparatus; and
a module which decodes the second encoded video file edited by the second edition module and displays the decoded second encoded video file; wherein:
the first edition module in the first apparatus imports, from the recording module, the first encoded video file generated from the same video information as the second encoded video file is generated, and the first edition module edits the first encoded video file in accordance with the edition command from the second apparatus so that the edition process of the second encoded video file in the second apparatus is automatically reflected on the edition process of the first encoded video file.

12. A moving picture editing system according to claim 11, wherein:
the encoding module generates encoding information in parallel with the encoding process of the video information, and the encoding information is used for the edition process of the first or second encoded video file.

13. A moving picture editing system according to claim 1, wherein:
the encoding module generates encoding information in parallel with the encoding process of the video information, and the encoding information is used for the edition process of the first or second encoded video file.

14. A moving picture editing system according to claim 2, wherein:
the encoding module generates encoding information in parallel with the encoding process of the video information, and the encoding information is used for the edition process of the first or second encoded video file.

15. A moving picture editing system according to claim 3, wherein:
the encoding module generates encoding information in parallel with the encoding process of the video information, and the encoding information is used for the edition process of the first or second encoded video file.

16. A moving picture editing system according to claim 4, wherein:
the encoding module generates encoding information in parallel with the encoding process of the video information, and the encoding information is used for the edition process of the first or second encoded video file.

17. A moving picture editing system according to claim 5, wherein:
the encoding module generates encoding information in parallel with the encoding process of the video information, and the encoding information is used for the edition process of the first or second encoded video file.

18. A moving picture editing system according to claim 6, wherein:
the encoding module generates encoding information in parallel with the encoding process of the video information, and the encoding information is used for the edition process of the first or second encoded video file.

19. A moving picture editing system according to claim 7, wherein:
the encoding module generates encoding information in parallel with the encoding process of the video information, and the encoding information is used for the edition process of the first or second encoded video file.

20. A moving picture editing system according to claim 8, wherein:
the encoding module generates encoding information in parallel with the encoding process of the video information, and the encoding information is used for the edition process of the first or second encoded video file.
